(19) United States
(12) Patent Application Publication
(10) Pub. No.: US 2016/0302621 A1
(43) Pub. Date: Oct. 20, 2016

(54) Food Storage Box

(71) Applicant: Nasser Yafei, Liverpool (GB)

(72) Inventor: Nasser Yafei, Liverpool (GB)

(21) Appl. No.: 14/690,691

(22) Filed: Apr. 20, 2015

(51) Int. Cl. A47J 47/14; B65D 85/36; B65D 5/66; B65D 5/02; B65D 5/42

(52) U.S. Cl. CPC A47J 47/145; B65D 5/0254; B65D 5/4266; B65D 5/6602; B65D 85/36; B65D 2585/366

(57) ABSTRACT

A storage box (10) suitable for containing a pizza or other foodstuff comprises a tray portion (11) and a lid portion (12), the lid having a face region (20) which extends over the tray portion when the box is in a closed condition, and the lid portion having a pre-fabricated fold line (13) which extends across the face region whereby in use access may be gained to the contents of the box by folding a first region of the lid portion about said prefabricated fold line and whereby the remaining, second region of the lid portion may remain in the original, closed position over the tray portion.

This application is related to British Application no. GB1218632.6 filed Oct. 17, 2012, published Apr. 23, 2014 as GB2507064. Application GB1218632.6 is hereby incorporated by reference in its entirety.

### BACKGROUND

1. Field of the Invention

This invention relates to a storage box for containing a pizza (or other food stuffs) and to a foldable blank for forming a storage box for containing a pizza.

It relates in particular, though not exclusively, to a food storage box for so-called “take-away” food and the box may be employed for use with either heated or unheated foodstuffs.

2. Description of the Prior Art

Many designs of pizza storage boxes are known and generally comprise a tray portion which provides a base for supporting a pizza, and a lid portion to cover the pizza and assist in retaining heat during transportation of the pizza to a customer.

Although conventional, known pizza boxes perform satisfactorily for transportation of a pizza, they are not entirely satisfactory when opened and used by a recipient. Two problems are commonly experienced with conventional pizza boxes. One is that on opening it is found that the relatively large lid is cumbersome, especially if the lid is hingedly connected to the tray portion instead of being totally removable. A second problem is that of heat loss following opening of the box. Although one or more consumers initially may enjoy freshly cooked hot portions of a pizza, by the time the consumers reach the remaining portions in the box it is found that those portions are relatively cool and less attractive to consume.

The present invention seeks to provide an improved food storage box, and a blank for forming a food storage box in which at least some of the aforedescribed disadvantages of conventional pizza boxes are mitigated or overcome.

### SUMMARY OF THE INVENTION

In accordance with one aspect of the present invention there is provided a storage box suitable for containing a pizza, the box comprising a tray portion and a lid portion, the lid having a face region which extends over the tray portion when the box is in a closed condition, and the lid portion having a pre-fabricated fold line which extends across the face region whereby in use access may be gained to the contents of the box by folding a first region of the lid portion about said prefabricated fold line whereby the remaining, second region of the lid portion may remain in the original, closed position over the tray portion.

Accordingly it will be understood that the provision of a lid portion which is prefabricated with a fold line extending across the lid portion allows part of the lid to remain in situ to assist in conserving heat of the pizza inside one part of the box when part of the lid is folded back to allow access to a part of the pizza for initial consumption.

The box may be relatively thin in comparison with the size of the face portion. Typically the face portion may have a minimum dimension between opposite edges which is at least three and more typically at least five times the thickness of the box.

Although a box of a relatively thin type is particularly suitable for storage of a pizza, it is to be understood that irrespective of whether or not the box is of a thin type, the invention may provide a box suitable for storage of other food stuffs. The storage box of the invention may be constructed from materials which enable it to be suitable for storage of heated food which is to be kept warm and/or food at ambient temperature.

The lid portion may comprise more than one prefabricated fold line whereby the lid may be folded back successively in two or more stages. Thus the lid may be folded back in a manner which results in there being two or more layers of lid material at the unfolded region of the lid portion, thereby enhancing heat retention at the underlying region of the box. The lid portion may comprise two or more prefabricated fold lines which are parallel with one another. Two pre-fabricated parallel fold lines may be provided close together and typically may be separated by a distance corresponding to the thickness, or related to other features such as compressibility of the box material.

The invention envisages that typically the lid portion will be formed integrally with the tray portion and be integrally connected at a prefabricated fold line. Alternatively, however, the present invention may be applied to a storage box of the type having a lid portion which is removable from the tray portion.

In a construction in which the lid portion is integral with the tray portion either all or only part of the lid portion may be moveable relative to the tray portion. It is envisaged that typically all of the lid portion will be moveable relative to the tray portion but the present invention does not exclude the alternative of a part of the area of the lid portion face region being retained relative to the tray portion, for example by adhesive or interlocking formations.

The or each preformed fold line extending across the lid face region may extend parallel with an edge of the lid. However that is not essential and in the case of a lid portion which is square a fold line may extend diagonally. More generally in the case of a polygonal shaped lid portion, whether of square, rectangular, hexagonal or other shape, a fold line may extend across the face region along a line of symmetry of the lid portion whereby one half of the lid may be folded back to lie directly over the other half such that at said other half there are then two thicknesses of lid material, thus assisting the aforementioned heat retention for that part of the tray portion and contents which remain covered by the lid portion.

The lid portion may be of the kind having side regions in the form of walls which extend downwards from edges of the lid face region to lie alongside tray portion walls that extend upwards from the edges of a base region of the tray when the box is in a closed condition. Typically the lid and tray portions will each comprise a front wall, a rear wall and two side walls. If the lid and tray portions are integral with one another the rear wall of the lid portion will serve also as the rear wall of the tray portion. The present invention teaches that lid side walls adjacent the ends of the or each prefabricated fold line of the lid face region are pre-cut thereby to allow folding of the lid about said fold line(s). Said side wall cuts may extend substantially perpendicular to the plane of the lid face region.

The invention further teaches that side walls of a foldable part of the lid portion may be folded back such that when the folded part of the lid portion rests on an unfolded part of the lid the side walls of the folded part may be folded back, downwards to lie alongside sides of the box. Likewise the lid portion front wall may be folded back to lie alongside a rear wall of the lid or tray portion.

Preferably when the box is in a closed condition the lid side walls lie inwards of the tray portion side walls. Thus when the side walls of the folded back part of the lid portion are folded back to lie alongside the box side walls they lie in contact with the tray portion side walls. The tray side walls preferably are provided with pre-formed slits or slots into which edges, and in particular corners, of the folded side walls of the lid may be inserted thereby neatly to hold in position the folded back parts of the lid. Similarly a rear wall may be provided with at least one pre-formed slit or slot into which an edge, such as a corner, of the lid portion front wall may be inserted.

The lid portion of the box may be provided in a conventional manner with a locking tab for engaging with a slot in the tray portion to secure the lid in the closed position. Furthermore air holes may be provided in a conventional manner to reduce condensation within the box. However, in contrast to the conventional positioning of vent holes in the rear wall of the tray portion, the present invention teaches that the or each said hole is positioned solely in that part of the box the inside of which becomes directly exposed when part of the lid is folded back. Thus the part of the inside of the box which remains covered by part of the lid preferably is devoid of any said air holes.

Optionally the base and side walls of the tray portion may be provided with a severable transversely extending perforation line whereby the box may be split into two parts. The transversely extending line preferably extends at a position substantially midway between the front and rear walls of the tray portion such that when the two separated parts of the box are slid one relative to the other into a nested configuration the resulting box is of a closed form and has a size approximately half that of the original box prior to separation into two parts.

A part of the lid portion of the storage box may be provided with at least one removable blank region whereby, following removal of the blank, the lid portion comprises an aperture for location of a container such as a container for dips and sauces. Edges of the aperture may be provided with one or more tab regions each deformable in position relative to the lid portion, for example in consequence of provision of perforations or an indentation line in the material of the lid portion whereby the or each said tab portion assists in securely retaining a container in position in the aperture.

In accordance with another aspect of the present invention there is provided a foldable blank which is foldable to provide a storage box for containing a pizza and wherein the part of the blank that provides a face region of the lid portion of the resulting storage box is prefabricated with a fold line which extends across said base region between edges of the face region.

The foldable blank may have one said fold line extending across the face region and preferably said fold line is positioned on a line of symmetry of the face region. Alternatively or additionally, the face region may be provided with two or more fold lines each extending across the face region.

The or each face region fold line may be formed by a conventional technique such as by locally indenting the material of the lid portion or by forming lines of perforations which each extend part way through the thickness of the material of the lid portion.

Suitable materials for forming the box include those already well known, such as corrugated cardboard, paper board and fibre board.

Although some features of the present invention are described herein in combination with other features, it is to be understood that one or more of said features may be provided independently of one another or in combinations which differ from those specifically described.

### BRIEF DESCRIPTION OF THE DRAWINGS

Embodiments of the present invention will be described, by way of example only, with reference to the accompanying diagrammatic drawings in which:—

FIG. 1 is a perspective view of a pizza storage box in accordance with a first embodiment of the present invention in a first stage of opening;

FIGS. 2 & 3 show the box of FIG. 1 in two successive stages of opening;

FIG. 4 shows the box of FIG. 1 in a completed, partly opened condition;

FIG. 5 is a view in the direction of the arrow A of FIG. 4;

FIG. 6 is a perspective view of a pizza storage box in accordance with a second embodiment of the present invention;

FIG. 7 is a plan view of a foldable blank for forming the storage box of FIG. 6;

FIGS. 8a and 8b are side views of the box of FIG. 6 with two parts separated, and

FIG. 8c is a side view showing the two parts of the box of FIG. 6 nested together.

Several drawings have been presented to illustrate features of the present invention. The scope of the present invention is not limited to what is shown in the figures.

### DETAILED DESCRIPTION OF THE PREFERRED EMBODIMENTS

A pizza storage box 10 is formed in its entirety by folding a single sheet of corrugated cardboard to provide a tray portion 11 to which a lid portion 12 is hingedly secured about a first fold line 13.

The tray portion 11 comprises a base 14 from which four walls 15-18 extend upwardly, perpendicular to the base, so as to define the depth of the box. Two 15,16 of the walls are side walls which extend from edges of the base that are perpendicular to the fold line 13, one 17 is a front wall and one 18 is a rear wall that extends upwards from the base to said first fold line 13.

The front wall 17 is of a double folded form such that, in known manner, tabs (not shown) that extend from neighbouring ends of the side walls 15,16 are held captive between the two folded sections of the front wall.

The lid portion 12 has a face region 20, comprising two portions 20a, 20b, from which extend two side walls 21,22 and a front wall 23. In the closed condition of the box these three walls lie inwards of the tray portion side walls 15,16 and front wall 17 respectively.

In contrast to a conventional pizza box lid portion, in accordance with the present invention the face region 20 of the lid portion 12 is preformed with a fold line 25 that extends parallel with the first fold line 13 and lies midway between said fold line 13 and the front edge 26 of the face region. The face region portions 20a, 20b lie at respective sides of the fold line 25. In this example the fold line 25 is formed by a technique known per se and comprises two rows of perforations extending side by side and slightly spaced apart, each perforation extending only part way through the thickness of the lid portion material.

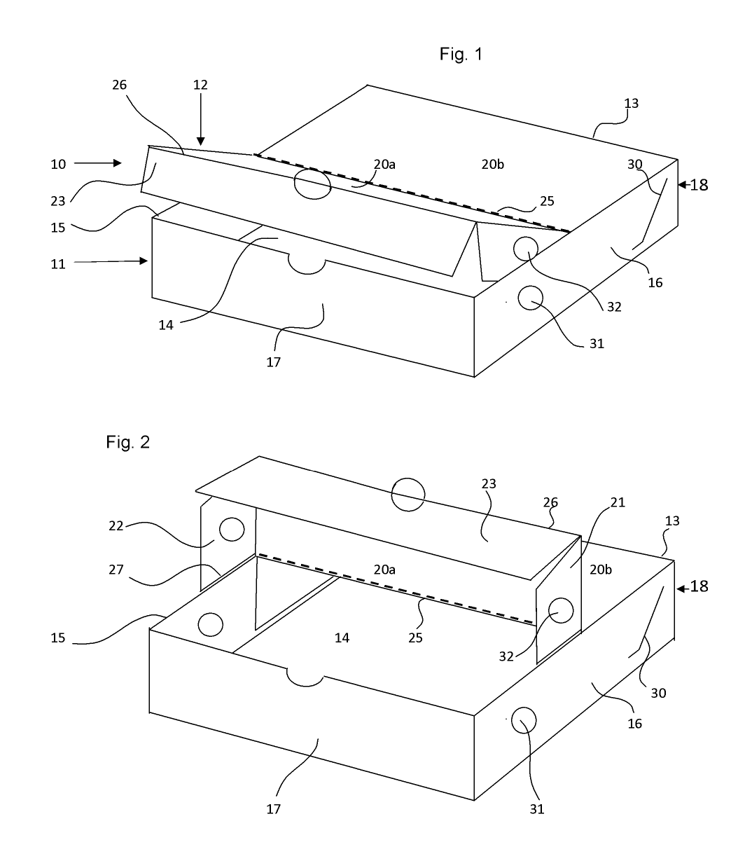

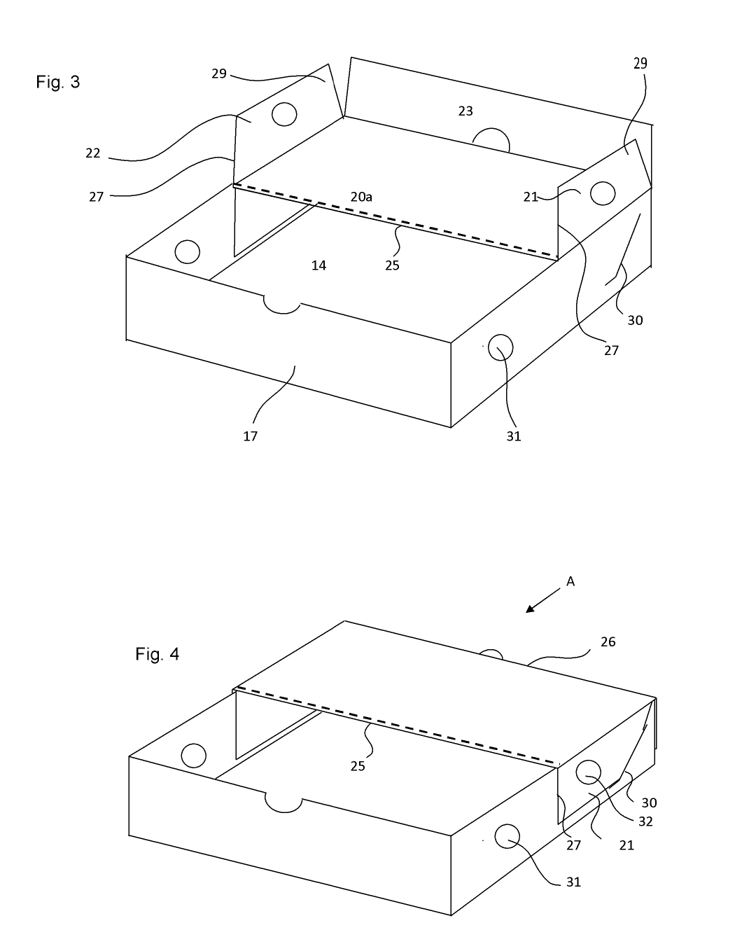

Each side wall 21,22 of the lid portion is preformed with cut edges 27 which each extend from an end of the fold line 25 to the distal edge region of the side wall, in a direction substantially perpendicular to the face region 20 as considered when the box is in a closed condition. The presence of the cut edges 27 accordingly allows the face region portion 20a of the lid to be folded about the intermediate fold line 25 through the positions shown successively in FIGS. 1 and 2 until one half 20a of the face region lies directly over the other half 20b of the face region which has remained in its original position, as shown in FIG. 3. Thus in effect the front, foldable, part of the lid portion 12 can be folded back to wrap around the top, back and sides of the unopened portion of the box.

To assist folding back of the front, foldable part of the lid portion 12 parallel pre-fabricated fold lies are provided at the hinge portions between the lid and the side flaps of that foldable part of the lid portion.

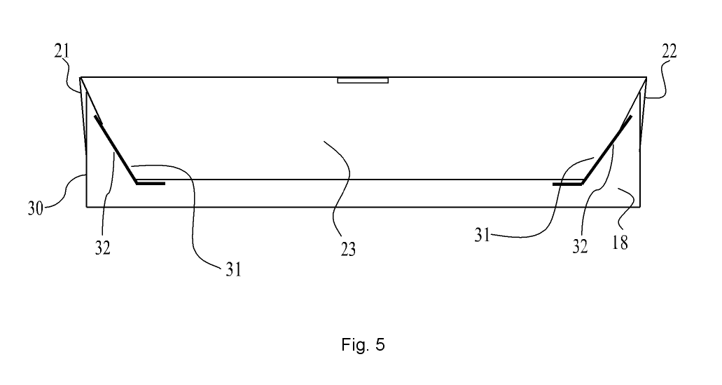

For neatness the front wall 23 and neighbouring sections of the side walls of the lid portion can then be folded downwards to the configuration shown in FIG. 4. By slightly lifting the folded lid portion temporarily corner regions 29 of the lid side walls can be tucked into slots 30 preformed in the tray portion side walls 15,16 (see FIG. 4) and corner regions 31 of the lid front wall 24 can be tucked into slots 32 pre-formed in the rear wall 18 (see FIG. 5).

Accordingly, in the configuration shown in FIG. 4 the portions of a pizza or other heated foodstuff in one half of the inside of the box is readily accessible whilst the remainder in the other half of the box is in a substantially closed environment which thereby minimising the rate of heat loss.

Access to the remainder of the pizza may be achieved either by folding back all of the lid portion material about the rear fold line 13 or by tilting the box forwards such that the pizza slides forwards to the open half of the box.

To further assist in minimising the rate of heat loss the ventilation apertures conventionally provided in the rear wall 18 of a tray portion for the purpose of avoiding or reducing condensation are instead absent from those surfaces of the box which define the half of the box which remains substantially closed. Thus in accordance with the present invention ventilation apertures 31 are provided solely in that half of each tray portion side wall 15,16 which is closest to the front wall 17, and with apertures 32 being provided in the sections of the lid portion side walls 21,22 for alignment with tray apertures 31.

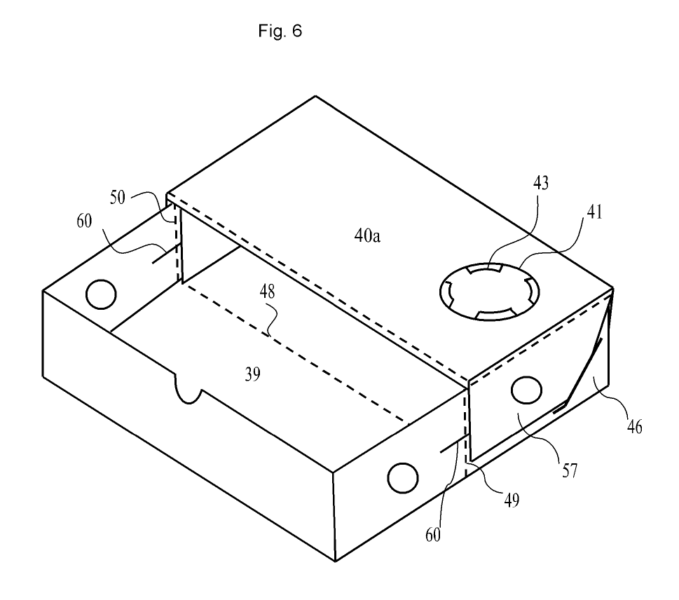

A pizza box in accordance with a second embodiment of the present invention is shown in FIGS. 6 to 8.

The general manner of the construction of this box has substantial similarities with that of the first described embodiment of the invention. However, it differs in two significant respects in consequence of provision of additional features.

One additional feature is that the foldable portion 40a of the lid is provide with a peripherally continuous perforation line 41 whereby that part of the lid material within the perforation line 41 is in the form of a blank 42 which can be removed by a simple pressing operation to result in a circular opening into which four tab portions 43 extend. Each tab portion is readily flexible relative to the lid portion 40a as a result of perforation lines 44 which extend parallel with an inner edge 45 of each tab.

The opening resulting from the removal of the blank 42 provides a convenient location for inserting and securing in position containers such as containers of dips or sauces. Although in this embodiment only one push-out blank region 42 is illustrated, it is to be understood that two or more push-out regions, optionally of different sizes, may be provided.

The second additional feature by which the storage box of the second embodiment differs from that of the first embodiment is that the box is separable into two parts whereby, following separation, the two parts may be nested together to provide a closed storage box smaller in size than the size of the original storage box.

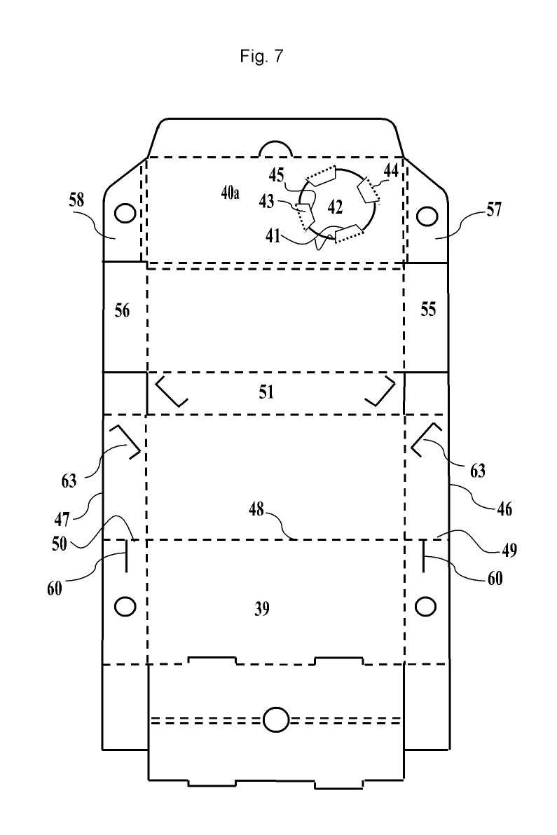

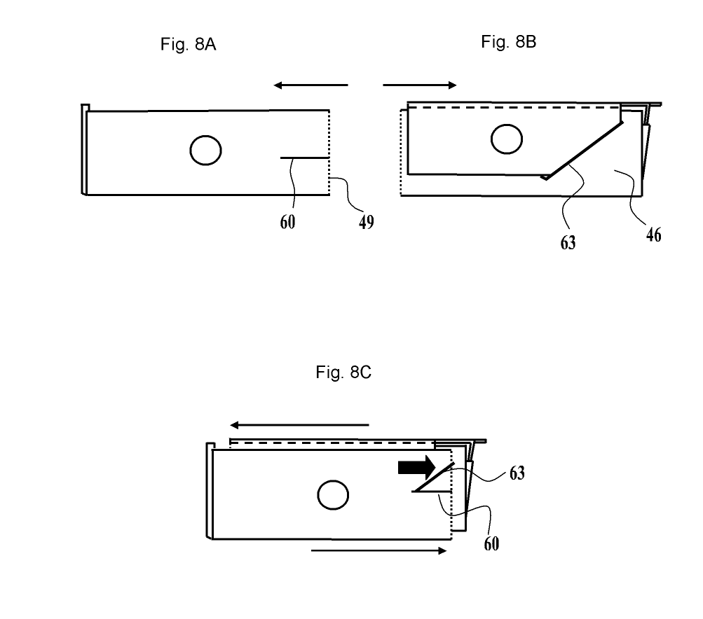

This is achieved by providing the base 39 and the tray portion side walls 46, 47 with lines of separable perforations 48, 49, 50 as best seen in FIG. 7. Following severance along the lines 48, 49, 50 the front part of the tray portion may be slid towards the rear wall 51 of the tray portion with the side walls 46, 47 of the front portion then positioned securely between the rear portion side wall regions 55, 56 and the folded back side walls 57, 58 of the lid portion. FIGS. 8a and 8b show the two parts of the box separated from one another and FIG. 8c shows the two parts of the box nested together to provide a closed container of substantially half the size of the original container.

In FIG. 7 slits or cut lines 60 are shown in the front portions 61 of the tray and the purpose of those lines 60 is best understood by reference to FIG. 8c. As shown in FIG. 8c the lines 60 allow a part of the side wall to lie inwards of the inclined slit line 63 and another part to lie outwards of the slit line, thereby resulting an a frictional engagement which assists in resisting any tendency of the two parts of the box to slide apart from the configuration shown in FIG. 8c.

From the foregoing it will be understood that the present invention provides an improved pizza box which facilitates a reduction in heat loss from a part of a pizza whilst another part is being consumed, and additionally avoids the awkwardness associated with the opening of a conventional, inflexible hinged lid. Thus the consumer is able more comfortably to enjoy the whole of the pizza without experiencing the usually encountered loss of temperature of the pizza. Whereas a pizza might normally fall temperature over a fifteen minute period to 40° C. once a box has been opened, by use of a pizza box in accordance with the present invention, the part of a pizza retained within the essentially unopened section of the storage box is found to fall only to about 50° C.

These advantages of the present invention are achieved without the need to substantially re-design the packaging material or provide additional components. In particular the changes required to a conventional foldable blank for forming a pizza box are confined to provision of an additional fold line extending across the lid portion, cuts in the lid side walls and repositioning of the ventilation apertures.

Several descriptions and illustrations have been provided to aid in understanding the present invention. One with skill in the art will realise that numerous changes and variations may be made without departing from the spirit of the invention. Each of these changes and variations is within the scope of the present invention.

1. A storage box suitable for containing a pizza, the box comprising a tray portion and a lid portion, the lid having a face region which extends over the tray portion when the box is in a closed condition, and the lid portion having a pre-fabricated fold line which extends across the face region whereby in use access may be gained to the contents of the box by folding a first region of the lid portion about said prefabricated fold line whereby the remaining, second region of the lid portion may remain in the original, closed position over the tray portion.

2. A storage box according to claim 1 wherein the lid and tray portions are integrally connected at a prefabricated fold line.

3. A storage box according to claim 1 wherein the lid portion comprises at least one prefabricated fold line which extends across the lid face region in a direction substantially parallel with an edge of the lid.

4. A storage box according to claim 3 wherein the or each said preformed fold line extends parallel with a fold line about which the lid portion is integrally connected to the tray portion.

5. A storage box according to claim 1 wherein the lid portion is of a polygonal shape and the face region of the lid portion comprises a fold line which extends across the face region along a line of symmetry of said face portion.

6. A storage box according to claim 1 wherein the lid portion comprises side walls which extend downwards from edges of the face region of the lid portion to lie alongside side walls that extend upwards from edges of a base region of the tray portion, wherein side walls of the lid portion adjacent the end of the or each prefabricated fold line of the lid base region are pre-cut to allow folding of the lid about said prefabricated fold line(s), and wherein said side wall cuts extend substantially perpendicular to the plane of the lid face region.

7. A storage box according to claim 6 wherein side walls of a foldable part of the lid portion may be folded back such that when the folded part of the lid portion rests on an unfolded part of the lid the side walls of the folded part may be folded back to lie alongside side walls of the box.

8. A storage box according to any one of claim 6 wherein when the storage box is in a closed condition the lid side walls lie inwards of the tray portion side walls whereby, when the side walls of the folded back part of the lid portion are folded to lie alongside the box side walls they lie in contact with tray portion side walls.

9. A storage box according to claim 1 wherein the tray portion comprises side walls, wherein the lid comprises side walls and wherein side walls of the tray portion are preformed with slits or slots into which edges, such as corner regions of the lid side walls may be inserted.

10. A storage box according to claim 1 wherein the lid portion comprises a front wall which extends downwards from an edge of the face region of the lid portion to lie alongside a front wall that extends upwards from a front edge of a base region of the tray portion when the box is in a closed condition.

11. A storage box according to claim 10 wherein the tray portion comprises a rear wall pre-formed with at least one slit or slot into which an edge, such as a corner region, of the lid front wall may be inserted when the lid portion is folded to bring said lid front wall into contact with the rear wall of the tray portion.

12. A storage box according to claim 1 wherein the lid portion comprises a prefabricated fold line which extends across the lid face region in a direction inclined relative to an edge of the lid portion.

13. A storage box according to claim 12 wherein the lid face region is square and comprises a prefabricated fold line which extends diagonally across said face region.

14. A storage box according to claim 1 wherein the storage box comprises at least one vent aperture in at least one of the tray and lid portions, and wherein the region of the storage box which remains covered when a part of the lid portion is folded along said prefabricated fold line to open a part of the box is devoid of vent apertures.

15. A storage box according to claim 1 wherein the tray portion of the box is severable into two portions whereby said two portions may be nested together to form a closed storage box of a size smaller than the original size of the storage box.

16. A storage box according to claim 15 wherein the tray portion is formed with a perforation line at which the tray portion is severable into two parts.

17. A storage box according to claim 1 wherein the lid portion comprises a removable blank whereby following removal of the blank an aperture is formed for location of a container.

18. A storage box according to claim 17 wherein at least one tab formation extends inwards towards a centre of the aperture and is deformable for frictional engagement with an inserted container.

19. A foldable blank which is foldable to provide a storage box for containing a pizza and wherein the part of the blank that provides a face region of the lid portion of the resulting storage box is prefabricated with a fold line which extends across said face region between edges of the face region.

20. A foldable blank according to claim 19 wherein said fold line extending across the face region is positioned on a line of symmetry of the face region.
